(19) United States
(12) Patent Application Publication
(10) Pub. No.: US 2020/0226995 A1
(43) Pub. Date: Jul. 16, 2020

(54) GATE DRIVE UNIT CIRCUIT, GATE DRIVE CIRCUIT AND LIQUID CRYSTAL DISPLAY DEVICE

(71) Applicants: Nanjing CEC Panda FPD Technology Co., Ltd., Nanjing, Jiangsu (CN); Nanjing CEC Panda LCD Technology Co., Ltd., Nanjing, Jiangsu (CN); Nanjing Huadong Electronics Information & Technology Co., Ltd., Nanjing, Jiangsu (CN)

(72) Inventor: Chao DAI, Nanjing, Jiangsu (CN)

(21) Appl. No.: 16/627,076

(22) PCT Filed: Mar. 30, 2018
(86) PCT No.: PCT/CN2018/081354

§ 371 Date: Dec. 27, 2019

(30) Foreign Application Priority Data
Jun. 27, 2017 (CN) 201710497914.7

(51) Int. Cl. G09G 3/36; G02F 1/1368; G02F 1/1362

(52) U.S. Cl. CPC G09G 3/3677; G02F 1/136286; G02F 1/1368

(57) ABSTRACT

A gate driving unit circuit includes a pull-up control module, a pull-up module, a pull-down clearing module, and a maintaining module; wherein the maintaining module includes a first sub-maintaining module and a second sub-maintaining module, which are symmetric to each other. The first sub-maintaining module inputs a first low-frequency clock signal, and the second sub-maintaining module inputs a second low-frequency clock signal that is opposite in phase to the first low-frequency clock signal. The first sub-maintaining module and the second sub-maintaining module alternately operate under the control of the first low frequency clock signal and the second low frequency clock signal for maintaining the internal node signal at a low level during the inactive period of the display scan. Therefore, the negative influence of the long-term operation of the module on the thin film transistor is effectively avoided, and the reliability of the circuit is improved.

### TECHNICAL FIELD

The present invention relates to the field of liquid crystal display technologies, and particularly to a gate driving unit circuit, a gate driving circuit, and a liquid crystal display device.

### TECHNICAL BACKGROUND

Due to the demand for narrow frame applications of liquid crystal displays, the current mainstream technology directly integrates the scanning line driving function of the existing gate chip (gate IC) into the array substrate of the liquid crystal display, and utilizes the existing thin film transistor process to fabricate a gate scan circuit with a shifting register function. Recently, large-size TVs are increasingly using this technology, and this puts higher demands on the design of the gate scanning circuit, whether in the reliability of the circuit or in the yield of the production.

FIG. 1 is a design of a gate driving unit circuit used in the design of a conventional liquid crystal display product. As shown in FIG. 1, the existing gate driving unit circuit mainly includes several parts, namely a pull-up control module (M1), a pull-up module (M10), a pull-down clearing module (M9), and a maintaining module (M3, M4A, M5, M6A, M6, M7, M8, M11), a clearing the reset module (M2, M12), and a bootstrap capacitor (C1). The main design defect of this gate drive circuit is that the maintaining module is controlled by a high-frequency clock signal that drives the scan signal line, so that in half of the time it cannot be maintained, and the long-term operation of the maintaining module adversely affects the thin film transistor. Secondly, this design uses a clock signal to control the maintaining. If the TFT size increases, the signal line load will increase, which will reduce the circuit design margin. In addition, this circuit design uses a scanning signal line for cascade, and the scanning signal line is susceptible to various factors in the display area, which has a negative impact on circuit cascade. Moreover, the circuit design is also not repairable, that is, if any one of transistors is damaged, the circuit will fail.

### SUMMARY OF THE INVENTION

In order to solve the above technical problem, according the one aspect of the invention, there is provided a gate driving unit circuit, comprising: a pull-up control module, a pull-up module, a pull-down clearing module, and a maintaining module; wherein the maintaining module comprises a first sub-maintaining module and a second sub-maintaining module, which are symmetric to each other, the first sub-maintaining module inputs a first low frequency clock signal, and the second sub-maintaining module inputs a second low frequency clock signal that is opposite in phase to the first low frequency clock signal, the first sub-maintaining module and the second sub-maintaining module alternately operate under the control of the first low frequency clock signal and the second low frequency clock signal for maintaining the internal node signal at a low level during the inactive period of a display scan.

According a preferred embodiment of the invention, said first sub-maintaining module comprises a first maintaining control node generating module and a first node maintaining module, and said second sub-maintaining module comprises a second maintaining control node generating module and a second node maintaining module; the first maintaining control node generating module is for generating a first maintaining control node, and the second maintaining control node generating module is for generating a second maintaining control node; the first node maintaining module maintains the internal node signal at a low level based on the control of the first maintaining control node, and the second node maintaining module maintains the internal node signal at a low level based on the control of the second maintaining control node.

According a preferred embodiment of the invention, the first maintaining control node generating module includes a fifth thin film transistor, a sixth thin film transistor, and a seventh thin film transistor; wherein for the fifth thin film transistor, the gate is connected to the first low-frequency clock signal, the source is connected to a high level, and the drain is connected to the first maintaining control node; for the sixth thin film transistor, the gate is connected to a pull-up control node, the source is connected to the first maintaining control node, and the drain is connected to a low level; and for the seventh thin film transistor, the gate is connected to a first preceding stage scanning signal, the source is connected to the first maintaining control node, and the drain is connected to a low level;

the second maintaining control node generating module includes a fifteenth thin film transistor, a sixteenth thin film transistor, and a seventeenth thin film transistor; wherein for the fifteenth thin film transistor, the gate is connected to a second low frequency clock signal, the source is connected a high level, the drain is connected to the second maintaining control node; for the sixteenth thin film transistor, the gate is connected to the pull-up control node, the source is connected to the second maintaining control node, and the drain is connected to the low level; and for the seventeenth thin film transistor, the gate is connected to the first preceding stage scan signal, the source is connected to the second maintaining control node, and the drain is connected to the low level.

According a preferred embodiment of the invention, the first maintaining control node generating module comprises a third thin film transistor, and the gate of the third thin film transistor is connected to the second low frequency clock signal, the source is connected to the first maintaining control node, and the drain is connected to the low level for performing a clearing reset of the first maintaining control node;

the second maintaining control node generating module includes a twenty-second thin film transistor, the gate of the twenty-second thin film transistor is connected to the first low frequency clock signal, the source is connected to the second maintaining control node, and the drain is connected to a low level for clearing reset of the second maintaining control node.

According a preferred embodiment of the invention, the first node maintaining module comprises a first scan signal maintaining module for maintaining a scan signal of the current stage, and the second node maintaining module comprises a second scan signal maintaining module that maintains the scan signal of the current stage.

According a preferred embodiment of the invention, the first scan signal maintaining module comprises a thirteenth thin film transistor, and for the thirteenth thin film transistor, the gate is connected to the first maintaining control node, the source is connected to the scan signal of the current stage, and the drain is connected to the low level; the second scan signal maintaining module includes the twenty-third thin film transistor, and for the twenty-third thin film transistor, the gate is connected to the second maintaining control node, the source is connected the scan signal of the current stage and the drain is connected to the low level.

According a preferred embodiment of the invention, said first node maintaining module comprises a first pull-up control node maintaining module for maintaining the pull-up control node, and said second node maintaining module comprises a second pull-up control node maintaining module for maintaining the pull-up control node.

According a preferred embodiment of the invention, the first pull-up control node maintaining module comprises an eighth thin film transistor, and for the eighth thin film transistor, the gate is connected to a first maintaining control node, the source is connected to the pull-up control node, and the drain is connected to the low level; the second pull-up control node maintaining module includes an eighteenth thin film transistor, and for the eighth thin film transistor, the gate is connected to the first maintaining control node, the source is connected to the pull-up the control node and the drain is connected to the low level.

According a preferred embodiment of the invention, further comprising a cascade module, wherein the cascade module is configured to output the cascade signal of the current stage.

According a preferred embodiment of the invention, the cascade module comprises an eleventh thin film transistor, the gate of the eleventh thin film transistor is connected to the pull-up control node, the source is connected to the clock signal of the current stage, and the drain is connected to the cascade signal of the current stage.

According a preferred embodiment of the invention, the first node maintaining module comprises a first cascade signal maintaining module for maintaining the cascade signal of the current stage, and the second node maintaining module comprises a second cascade signal maintaining module for maintaining the cascade signal of the current stage.

According a preferred embodiment of the invention, the first stage signal maintaining module comprises a fourteenth thin film transistor, and for the fourteenth thin film transistor, the gate is connected to the first maintaining control node, the source is connected to the cascade signal of the current stage, and the drain is connected to the low level; the second cascade signal maintaining module includes a twenty-fourth thin film transistor, and for the twenty-fourth thin film transistor, the gate is connected to the second maintaining control node, the source is connected to the cascade signal of the current stage, and the drain is connected to the low level.

According a preferred embodiment of the invention, the pull-up control module is configured to receive a first preceding stage scan signal to activate the current stage circuit, and comprises a first thin film transistor, the gate and the source of the first thin film transistor are connected to the first preceding stage scan signal, and the drain is connected to the pull-up control node, for receiving the first preceding stage scan signal to activate the current stage circuit.

According a preferred embodiment of the invention, the pull-up control module is configured to receive a first preceding stage cascade signal to activate the current stage circuit, and comprises a first thin film transistor, the gate of the first thin film transistor is connected to the first preceding stage cascade signal, the source is connected to a high level, and the drain is connected to the pull-up control node.

According a preferred embodiment of the invention, the pull-down clearing module is configured to receive a subsequent stage scan signal to perform a clearing reset of the pull-up control node, and comprises a ninth thin film transistor, the gate of the ninth thin film transistor is connected to the subsequent stage scan signal, the source is connected to the pull-up control node, and the drain is connected to the low level.

According a preferred embodiment of the invention, the pull-down clearing module is configured to receive a subsequent stage cascade signal to perform a clearing reset of the pull-up control node, and comprises a ninth thin film transistor, the gate of the ninth thin film transistor is connected to the subsequent stage cascade signal, the source is connected to the pull-up control node, and the drain is connected to the low level.

According a preferred embodiment of the invention, further comprising an auxiliary scan signal maintaining module, wherein the auxiliary scan signal maintaining module comprises a twenty-first thin film transistor, and the gate of the twenty-first thin film transistor is connected to the subsequent stage clock signal, the source is connected to the scanning signal of the current stage, and the drain is connected to the low level.

According a preferred embodiment of the invention, further comprising a nineteenth thin film transistor and a twentieth thin film transistor for maintaining the pull-up control node; for the nineteenth thin film transistor, the gate is connected to a preceding stage clock signal, the source is connected to a second preceding stage scan signal, the drain is connected to the pull-up control node; for the twentieth thin film transistor, the gate is connected to a startup signal, the source is connected to the pull-up control node, and the drain is connected to the low level.

According a preferred embodiment of the invention, further comprising a nineteenth thin film transistor and a twentieth thin film transistor for maintaining the pull-up control node; for the nineteenth thin film transistor, the gate is connected to a preceding stage clock signal, the source is connected to a second preceding stage cascade signal, the drain is connected to the pull-up control node; for the twentieth thin film transistor, the gate is connected to a startup signal, the source is connected to the pull-up control node, and the drain is connected to the low level.

According a preferred embodiment of the invention, the first maintaining control node generating module includes a fifth thin film transistor, a sixth thin film transistor, and a seventh thin film transistor; wherein for the fifth thin film transistor, the gate is connected to the first low-frequency clock signal, the source is connected to a high level, and the drain is connected to the first maintaining control node; for the sixth thin film transistor, the gate is connected to a pull-up control node, the source is connected to the first maintaining control node, and the drain is connected to a low level; and for the seventh thin film transistor, the gate is connected to a first preceding stage cascade signal, the source is connected to the first maintaining control node, and the drain is connected to a low level;

the second maintaining control node generating module includes a fifteenth thin film transistor, a sixteenth thin film transistor, and a seventeenth thin film transistor; wherein for the fifteenth thin film transistor, the gate is connected to a second low frequency clock signal, the source is connected a high level, the drain is connected to the second maintaining control node; for the sixteenth thin film transistor, the gate is connected to the pull-up control node, the source is connected to the second maintaining control node, and the drain is connected to the low level; and for the seventeenth thin film transistor, the gate is connected to the first preceding stage cascade signal, the source is connected to the second maintaining control node, and the drain is connected to the low level.

According a preferred embodiment of the invention, the pull-up module is configured to output a scan signal of the current stage, and comprises a tenth thin film transistor, the gate of the tenth thin film transistor is connected to the pull-up control node, the source is connected to the clock signal of the current stage, and the drain is connected to the scanning signal of the current stage.

According a preferred embodiment of the invention, the source of the first thin film transistor is disconnected from the first preceding stage scan signal and connected to a high level.

According a preferred embodiment of the invention, further comprising a clearing reset module, configured to perform a clearing reset of the pull-up control node and the current stage scan signal; the clearing reset module includes a second thin film transistor and a twelfth thin film transistor, wherein for the second thin film transistor, the gate is connected to a clearing reset signal, the source is connected to the pull-up control node, and the drain is connected to a low level; and for the twelfth thin film transistor, the gate is connected to the clearing reset signal, the source is connected to the scan signal of the current stage, and the drain is connected to the low level.

According a preferred embodiment of the invention, further comprising a clearing reset module, configured to perform a clearing reset of the pull-up control node, the current stage scanning signal, and the current stage cascade signal; the clearing reset module includes a second thin film transistor, a twelfth thin film transistor and a fourth thin film transistor; for the second thin film transistor, the gate is connected to the clearing reset signal, the source is connected to the pull-up control node, and the drain is connected to the low level; for the twelfth thin film transistor, the gate is connected to the clearing reset signal, the source is connected to the scan signal of the current stage, and the drain is connected to the low level; for the fourth thin film transistor, the gate is connected to the clearing reset signal, the source is connected to the current stage cascade signal, and the drain is connected to low level.

According a preferred embodiment of the invention, further comprising a bootstrap capacitor connected between the pull-up control node and the scanning signal line of the current stage.

According another aspect of the invention, there is provided a gate driving circuit, comprising a plurality stages of the gate driving unit circuit according to any one of the above embodiments.

According another aspect of the invention, there is provided a liquid crystal display device, comprising the gate driving circuit according to the above embodiment.

According to the embodiments of the present invention, the first sub-maintaining module and the second sub-maintaining module are symmetrically arranged, and the first low-frequency clock signal LC1 and the second low-frequency clock signal LC2 with opposite phases are used for input control, so that the two sub-maintaining modules work alternately, so that during the non-active period of the display scan, the internal node signal of the circuit is maintained at a stable low level, thereby effectively avoiding the negative impact of the module's long-term operation on the thin film transistor and ensuring that the circuit has high reliability and repairability.

### BRIEF DESCRIPTION OF DRAWINGS

FIG. 1 is a circuit diagram of a gate driving unit circuit in the prior art;

FIG. 2 is a circuit diagram of a gate driving unit circuit according to a first embodiment of the present invention;

FIG. 3 is a circuit diagram of a gate driving unit circuit according to a second embodiment of the present invention;

FIG. 4 is a repairing schematic diagram of a gate driving unit circuit according to the second embodiment of the present invention;

FIG. 5 is a circuit diagram of a gate driving unit circuit according to a third embodiment of the present invention;

FIG. 6 is a circuit diagram of a gate driving unit circuit according to a fourth embodiment of the present invention;

FIG. 7 is a schematic structural diagram of a gate driving circuit according to an embodiment of the invention;

FIG. 8 is a schematic diagram of driving signals of a gate driving circuit according to an embodiment of the invention;

FIG. 9 is a schematic structural view of a liquid crystal display device according to an embodiment of the invention.

### DESCRIPTION OF THE REFERENCE NUMERALS

01, pull-up control module, 02, cascade module, 03, pull-up module, 04, pull-down clearing module, 05, main maintaining module, 06, clearing reset module;

M1, first thin film transistor, M2, second thin film transistor, M3A, third thin film transistor, M4, fourth thin film transistor, M5A, fifth thin film transistor, M6A, sixth thin film transistor, M7A, seventh thin film transistor, M8A, eighth thin film transistor, M9, ninth thin film transistor, M10, tenth thin film transistor, M11, eleventh thin film transistor, M12, twelfth thin film transistor, M13A, thirteenth thin film transistor, M14A, fourteenth thin film Transistor, M5B, fifteenth thin film transistor, M6B, sixteenth thin film transistor, M7B, seventeenth thin film transistor, M8B, eighteenth thin film transistor, M1A, nineteenth thin film transistor, M4A, twentieth thin film transistor, M9A, twenty-first thin film transistor, M3B, twenty-second thin film transistor, M13B, twenty-third thin film transistor, M14B, twenty-fourth thin film transistor, C1, bootstrap capacitor;

Gn, the scanning signal line of the current stage, Tn, the cascade signal line of the current stage, netAn, pull-up control node, netBn, first maintaining control node, netCn, second maintaining control node, VGH, high level, VSS, low level, LC1, first low frequency clock signal, LC2, second low frequency clock signal, CKm, current stage clock signal, CKm−2, preceding stage clock signal, CKm+4, subsequent stage clock signal, Gn−4, first preceding stage scan signal, Tn−4, first preceding stage cascade signal, Gn−2, second preceding stage scan signal, Tn−2, second preceding stage cascade signal, Gn+6, subsequent stage scan signal, Tn+6, subsequent stage cascade signal, GSP, startup signal, CLR, clearing reset signal;

100, liquid crystal display device, 101, liquid crystal display substrate, 102, gate driver, 103, source driver, 104, circuit board, 1011, scan line, 1012, data line.

### DETAILED DESCRIPTION OF EMBODIMENTS

In order to more clearly illustrate the technical solutions of the embodiments of the present invention, some specific embodiments of the present invention will be described below with reference to the accompanying drawings. Obviously, the drawings mentioned in the following description are only some embodiments of the present invention, and those skilled in the art can obtain other drawings according to these drawings without creative work, and obtain other embodiments.

In order to simplify the drawings, only the parts related to the present invention are schematically shown in the drawings, and they do not represent the actual structure of the product. In addition, in order to make the drawings simple and easy to understand, in some of the figures only one of components having the same structure or function is schematically illustrated, or only one of them is marked. In the present context, “a” means not only “only this one” but also “more than one”.

### Embodiment 1

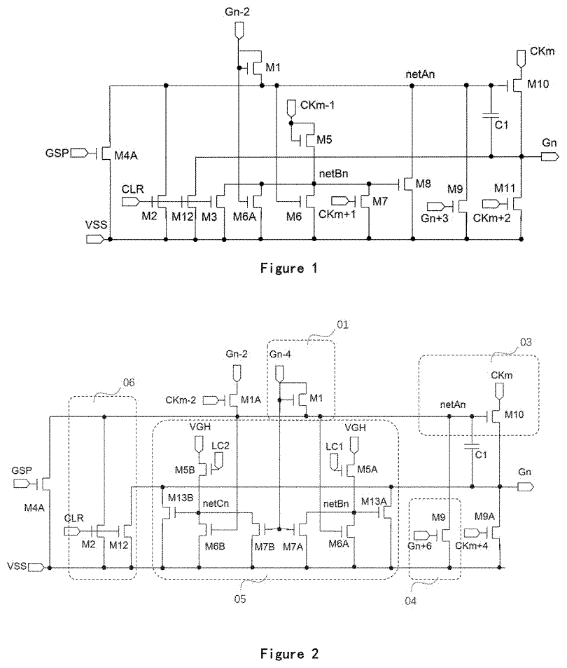

FIG. 2 is a circuit diagram of a gate driving unit circuit according to a first embodiment of the present invention. As shown in FIG. 2, the gate driving unit circuit of this embodiment includes a pull-up control module 01, a pull-up module 03, a pull-down clearing module 04, and a maintaining module 05.

The maintaining module 05 is configured to maintain the internal node signal of the circuit at a stable low level during the inactive period of the display scan, without being interfered by other signals, to ensure high reliability of the circuit. The maintaining module 05 includes a first sub-maintaining module and a second sub-maintaining module. The first sub-maintaining module and the second sub-maintaining module adopt a symmetric design, wherein the first sub-maintaining module inputs a first low-frequency clock signal LC1, and the second sub-maintaining module inputs a second low frequency clock signal LC2 with a phase opposite to the first low-frequency clock signal LC1. The first sub-maintaining module and the second sub-maintaining module alternately operate under the control of the first low frequency clock signal LC1 and the second low frequency clock signal LC2.

In this embodiment, the first sub-maintaining module includes a first maintaining control node generating module and a first node maintaining module connected to the first maintaining control node generating module; and the second sub-maintaining module includes a second maintaining control node generating module and a second node maintaining module coupled to the second maintaining control node generating module. The first maintaining control node generating module is coupled to the first low frequency clock signal, a first preceding stage signal, and the pull up control node, for generating the first maintaining control node netBn. The second maintaining control node generating module is coupled to the second low frequency clock signal, the first preceding stage signal, and the pull up control node, for generating the second maintaining control node netCn. The first node maintaining module performs maintaining of the internal node signal based on control of the first maintaining control node; and the second node maintaining module performs maintaining of the internal node signal based on control of the second maintaining control node. In this embodiment, the first preceding stage signal is the first preceding stage scan signal Gn−4, and the first preceding stage scan signal Gn−4 is the signal from the fourth stage preceding the current stage scan signal Gn. Actually, as long as the signal is the scanning signals preceding the scanning signal Gn of the current stage, such as Gn−3, Gn−2, etc., it can be implemented, and is within the protection scope of the present invention.

Specifically, the first maintaining control node generating module includes a fifth thin film transistor M5A, a sixth thin film transistor M6A, and a seventh thin film transistor M7A; and the second maintaining control node generating module includes a fifteenth thin film transistor M5B, a sixteenth thin film transistors M6B and a seventeenth thin film transistors M7B.

The gate of the fifth thin film transistor M5A is connected to the first low frequency clock signal LC1, the source of the fifth thin film transistor M5A is connected to the high level VGH, and the drain of the fifth thin film transistor M5A is connected to the first maintaining control node netBn, for charging the first maintaining control node netBn.

The gate of the sixth thin film transistor M6A is connected to the pull-up control node netAn, the source of the sixth thin film transistor M6A is connected to the first maintaining control node netBn, and the drain of the sixth thin film transistor M6A is connected to the low level VSS, for pulling down the first maintaining control node netBn during the output.

The gate of the seventh thin film transistor M7A is connected to the first preceding stage scan signal Gn−4, the source of the seventh thin film transistor M7A is connected to the first maintaining control node netBn, and the drain of the seventh thin film transistor M7A is connected to the low level VSS, for assisting to pull down the first maintaining control node netBn during the output.

The gate of the fifteenth thin film transistor M5B is connected to the second low frequency clock signal LC2, the source of the fifteenth thin film transistor M5B is connected to the high level VGH, and the drain of the fifteenth thin film transistor M5B is connected to the second maintaining control node netCn, for charging the second maintaining control node netCn.

The gate of the sixteenth thin film transistor M6B is connected to the pull-up control node netAn, the source of the sixteenth thin film transistor M6B is connected to the second maintaining control node netCn, and the drain of the sixteenth thin film transistor M6B is connected to the low level VSS, for pulling down the second maintaining control node netCn during the output.

The gate of the seventeenth thin film transistor M7B is connected to the first preceding stage scan signal Gn−4, the source of the seventeenth thin film transistor M7B is connected to the second maintaining control node netCn, and the drain of the seventeenth thin film transistor M7B is connected to the low level VSS, for assisting to pull down the second maintaining control node netCn during output.

In this embodiment, the first node maintaining module in the first sub-maintaining module includes a first scan signal maintaining module, and the second node maintaining module in the second sub-maintaining module includes a second scan signal maintaining module, wherein the two modules adopt symmetric design, and are both used to maintain the current stage scanning signal Gn during the inactive period of the display scan. The first scan signal maintaining module includes a thirteenth thin film transistor M13A, and the second scan signal maintaining module includes a twenty-third thin film transistor M13B.

The gate of the thirteenth thin film transistor M13A is connected to the first maintaining control node netBn, the source of the thirteenth thin film transistor M13A is connected to the scan signal line Gn of the current stage, the drain of the thirteenth thin film transistor M13A is connected to the low-level VSS. The gate of the twenty-third thin film transistor M13B is connected to the second maintaining control node netCn, the source of the twenty-third thin film transistor M13B is connected to the scanning signal Gn of the current stage, and the drain of the twenty-third thin film transistor M13B is connected to the low-level VSS.

In some implementations, the first maintaining control node generating module and the second maintaining control node generating module may be improved according to actual circuit requirements. For example, function modules for clearing resetting the first maintaining control node and the second maintaining control node are separately added (not shown in FIG. 2, but shown in FIG. 3). The first maintaining control node generating module further includes a third thin film transistor M3A, and the second maintaining control node generating module further includes a twenty-second thin film transistor M3B.

The gate of the third thin film transistor M3A is connected to the second low frequency clock signal LC2, the source is connected to the first maintaining control node netBn, and the drain is connected to the low level VSS, for clearing reset of the first maintaining control node netBn.

The gate of the twenty-second thin film transistor M3B is connected to the first low frequency clock signal LC1, the source is connected to the second maintaining control node netCn, and the drain is connected to the low level VSS, for performing clearing reset of the second maintaining control node netCn.

The pull-up control module 01 is configured to receive a first preceding stage signal to start the current stage circuit, and includes a first thin-film transistor M1. The gate and the source of the first thin film transistor M1 are both connected to the first preceding stage signal, and the drain of the first thin film transistor M1 is connected to the pull-up control node netAn, for pre-charging the pull-up control node netAn. In this embodiment, the first preceding stage signal is the first preceding stage scan signal Gn−4, and the first preceding stage scan signal Gn−4 is the signal from the fourth stage preceding the current stage scan signal Gn. Actually, as long as the signal is the scanning signals preceding the scanning signal Gn of the current stage, such as Gn−3, Gn−2, etc., it can be implemented, and is within the protection scope of the present invention.

In some embodiments, the pull-up control module 01 can also be modified to disconnect the source of the first thin film transistor M1 from the first preceding stage scan signal, and connect the source of the first thin film transistor M1 to the high-level VGH. It can prevent reverse leakage. It should be noted that the above improvements can also be included in the subsequent embodiments, but are not indicated in each figure.

The pull-up module 03 is configured to output the scan signal Gn of the current stage to the scan signal line of the current stage, and further provide driving to the scan line of the pixel display area. It includes the tenth thin film transistor M10, wherein the gate of the tenth thin film transistor M10 is connected to pull-up control node netAn, the source is connected to the current stage clock signal CKm, and the drain is connected to the current stage scan signal Gn.

The pull-down clearing module 04 is configured to receive a subsequent stage signal to clearing reset the pull-up control node netAn, and includes a ninth thin film transistor M9. Wherein the gate of the ninth thin film transistor M9 is connected to a subsequent stage signal, the source is connected to the pull-up control node netAn, and the drain is connected to the low level VSS. In this embodiment, the subsequent stage signal is the subsequent stage scan signal Gn+6, and the subsequent stage scan signal Gn+6 is the signal from the sixth stage subsequent to the current stage scan signal Gn. Actually, as long as the signal is the scanning signals subsequent to the scanning signal Gn of the current stage, such as Gn+1, Gn+2, Gn+5, etc., it can be implemented and is within the protection scope of the present invention.

In some embodiments, the gate drive unit circuit further includes a clearing reset module 06 that utilizes the clearing reset signal CLR to clear the internal nodes of the circuit at the end of each frame and when the device is turned off. The clearing reset module 06 includes a second thin film transistor M2 and a twelfth thin film transistor M12, for performing a clearing reset of the current stage pull-up control node netAn and the current stage scan signal Gn, respectively.

The gate of the second thin film transistor M2 is connected to the clearing reset signal CLR, the source is connected to the pull-up control node netAn, and the drain is connected to the low level VSS, for performing the clearing reset of the pull-up control node netAn.

The gate of the twelfth thin film transistor M12 is connected to the clearing reset signal CLR, the source is connected to the scan signal Gn of the current stage, and the drain is connected to the low level VSS, for clearing resetting the scan signal Gn of the current stage.

In some embodiments, the gate driving unit circuit further includes a nineteenth thin film transistor M1A and a twentieth thin film transistor M4A for maintaining the pull-up control node. The gate of the nineteenth thin film transistor M1A is connected to the preceding stage clock signal CKm−2, the source of the nineteenth thin film transistor M1A is connected to the second preceding stage signal, and the drain of the nineteenth thin film transistor M1A is connected to the pull-up control node netAn, wherein the second preceding stage signal may be the second preceding stage scanning signal Gn−2. The gate of the twentieth thin film transistor M4A is connected to the startup signal GSP, the source of the twentieth thin film transistor M4A is connected to the pull-up control node netAn, and the drain of the twentieth thin film transistor M4A is connected to the low level VSS. Specifically, in this embodiment, the pull-up control node netAn is maintained by the nineteenth thin film transistor M1A, and is assisted by the twentieth thin film transistor M4A for maintaining.

In this embodiment, the first and second node maintaining modules do not include a pull-up control node maintaining module for maintaining the pull-up control node netAn, and thus may maintain the pull-up control node netAn through the independent nineteenth thin film transistor M1A and twentieth thin film transistor M4A. It should be noted that, in other embodiments, when the first and second node maintaining modules further include a pull-up control node maintaining module for maintaining the pull-up control node netAn, the independent nineteenth thin film transistor M1A and twentieth thin film transistor M4A can be set as a function module to assist the maintaining of the pull-up control node netAn, or can be directly removed.

In some embodiments, the gate driving unit circuit may further include an auxiliary scan signal maintaining module, and the auxiliary scan signal maintaining module includes a twenty-first thin film transistor M9A for assisting in maintaining the current stage scanning signal Gn. The gate of the twenty-first thin film transistor M9A is connected to the subsequent stage clock signal CKm+4, the source is connected to the scanning signal Gn of the current stage, and the drain is connected to the low level VSS. In this embodiment, the auxiliary scan signal maintaining module and the two modules of the first and second scan signal maintaining modules are used for maintaining, and the partial repair of the circuit can be performed.

It should be noted that, in this embodiment, the independent twenty-first thin film transistor M9A is an auxiliary scan signal maintaining module that assists in maintaining the presence of the scanning signal Gn of the current stage. In other embodiments, when the first and second node maintaining modules do not include the first and second scanning signal maintaining modules, the auxiliary scanning signal maintaining module including the independent twenty-first thin film transistor M9A may be used as a functional module for independently maintaining the scanning signal Gn of the current stage, for replacing the first and second scanning signal maintaining modules.

In some embodiments, the gate driving unit circuit further includes a bootstrap capacitor C1 connected between the pull-up control node netAn and the current stage scan signal Gn for raising the potential of the pulling up control node netAn during output, so that the pull-up module 03 has sufficient current to drive the scanning signal Gn of the current stage.

In this embodiment, the first sub-maintaining module and the second sub-maintaining module are symmetrically arranged, and the first low-frequency clock signal LC1 and the second low-frequency clock signal LC2 with opposite phases are used for input control, so that the two sub-maintaining modules work alternately. Therefore, during the inactive period, the scanning signal of the circuit is maintained at a stable low level, without being interfered by other signals, and the negative influence of maintaining the long-term operation of the module on the thin film transistor can be avoided, thereby ensuring high reliability of the circuit.

### Embodiment 2

FIG. 3 is a circuit diagram of a gate driving unit circuit according to a second embodiment of the present invention. As shown in FIG. 3, the circuit configuration of the second embodiment is substantially the same as that of the first embodiment. The improvement thereof over the first embodiment is that the first node maintaining module in the first sub-maintaining module in this embodiment further includes a first pull-up control node maintaining module for maintaining the pull-up control node netAn, and the second node maintaining module in the second sub-maintaining module further includes a second pull-up control node maintaining module for maintaining the pull-up control node netAn.

The first pull-up control node maintaining module includes an eighth thin film transistor M8A. The gate of the eighth thin film transistor M8A is connected to the first maintaining control node netBn, the source is connected to the pull-up control node netAn, and the drain is connected to the low-level VSS. The second pull-up control node maintaining module includes an eighteenth thin film transistor M8A. The gate of the eighteenth thin film transistor M8B is connected to the second maintaining control node netCn, the source is connected to the pull-up control node netAn, and the drain is connected to the low-level VSS. Compared with the first embodiment, the eighth thin film transistor M8A and the eighteenth thin film transistor M8B which are symmetrical in this embodiment maintain the pull-up control node through the first maintaining control node netBn and the second maintaining control node netCn, respectively. They not only can achieve alternate work, but also simplify the circuit.

In this embodiment, the first and second pull-up control node maintaining modules maintain the pull-up control node netAn, and the first and second scan signal maintaining modules control the current stage scan signal Gn, so that the nineteenth thin film transistor M1A and the twentieth thin film transistor M4A for independently maintaining the pull-up control node netAn in the first embodiment may be replaced with the first and second pull-up control node maintaining modules, and the twenty-first thin film transistor M9A for assisting in maintaining the scanning signal line Gn of the current stage is removed.

In this embodiment, the first sub-maintaining module and the second sub-maintaining module are symmetrically arranged, and the first low-frequency clock signal LC1 and the second low-frequency clock signal LC2 with opposite phases are used for input control, so that the two sub-maintaining modules work alternately. Therefore, during the inactive period, the scanning signal of the circuit and the pull-up control node are maintained at a stable low level, without being interfered by other signals, and the negative influence of maintaining the long-term operation of the module on the thin film transistor can be avoided, thereby ensuring high reliability of the circuit.

### Embodiment 3

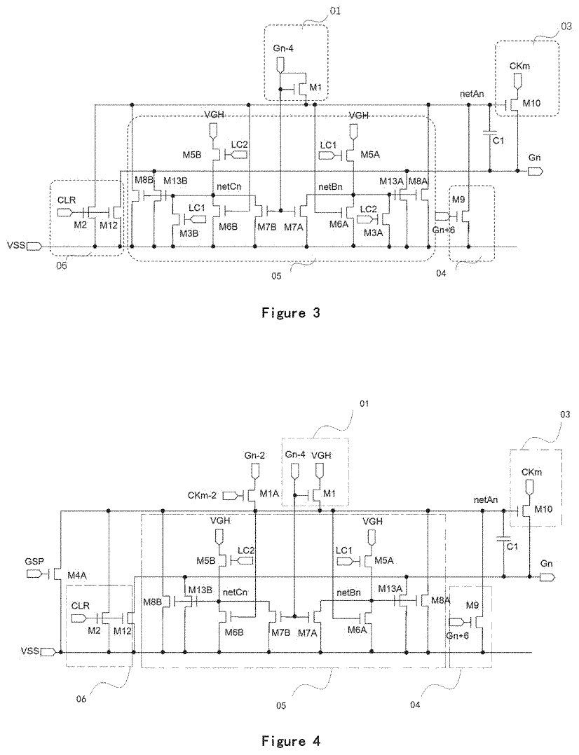

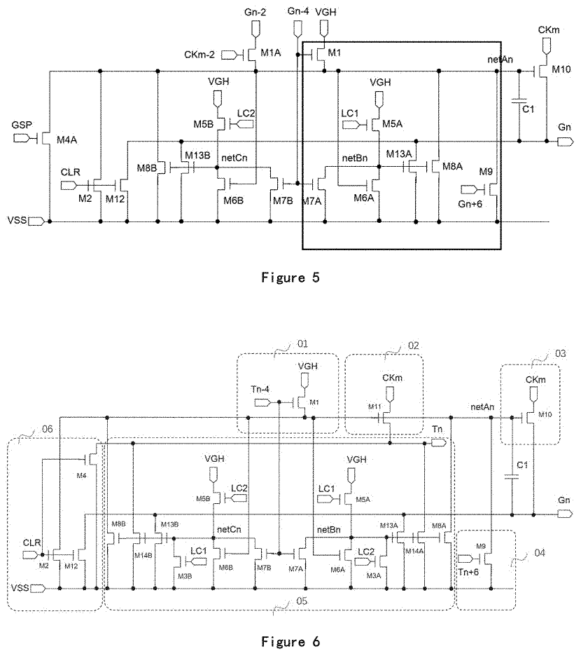

FIG. 4 is a circuit diagram of a gate driving unit circuit according to a third embodiment of the present invention. As shown in FIG. 4, the circuit structure of the third embodiment is substantially the same as that of the second embodiment, and the improvement over the second embodiment is that the independent nineteenth thin film transistor M1A and twentieth thin film transistor M4A are added, which. can be used as functional modules to assist in maintaining the pull-up control node netAn.

The gate of the nineteenth thin film transistor M1A is connected to the preceding stage clock signal CKm−2, the source is connected to the second preceding stage signal, and the drain is connected to the pull-up control node netAn. The second preceding stage signal may be the second preceding stage scan signal Gn−2.

The gate of the twentieth thin film transistor M4A is connected to the startup signal GSP, the source is connected to the pull-up control node netAn, and the drain is connected to the low level VSS.

In this embodiment, the nineteenth thin film transistor M1A and the twentieth thin film transistor M4A are used to assist restoring, and protect the pull-up control node netAn. Even if the nineteenth thin film transistor M1A and the twentieth thin film transistor M4A are removed, the circuit can still work. When the first thin film transistor M1 of the pull-up control module 01 and the ninth thin film transistor M9 of the pull-down clearing module 04 fail, the circuit can still work normally through the functions of the nineteenth thin film transistor M1A and the twentieth thin film transistor M4A.

In this embodiment, the first sub-maintaining module and the second sub-maintaining module are symmetrically arranged, and the first low-frequency clock signal LC1 and the second low-frequency clock signal LC2 with opposite phases are used for input control, so that the two sub-maintaining modules work alternately for maintaining the scanning signal of the circuit and the pull-up control node at a stable low level during the inactive period, the repairability of the circuit is improved by adding the auxiliary pull-up control node maintaining module, thereby ensuring that the circuit has higher reliability and repairability.

FIG. 5 is a schematic diagram of repair of a gate driving unit circuit according to a third embodiment of the present invention.

As shown in FIG. 5, it is the simplest circuit design that still retains the basic functions of the gate drive unit circuit after conversion. The portion within the black frame of the figure is the part of the components that can be laser cut off. M5B needs to be connected into the diode mode by laser.

It should be noted that the circuit repair can be performed by using a laser to cut off a part of the symmetrical design. Here, only the repair in the third embodiment is specifically described, but the above repair method can be used in the embodiment of the present invention without any limitation.

### Embodiment 4

FIG. 6 is a circuit diagram of a gate drive unit circuit in accordance with a fourth embodiment of the present invention. As shown in FIG. 6, the difference between the embodiment and the foregoing three embodiments is that a cascade module 02 and a cascade signal maintaining module corresponding thereto are added, and the cascade signal is mainly transmitted to the subsequent stage circuit for startup, and transmitted to the preceding stage circuit for pull-down clearing of the pull-up control node; and in this embodiment, the pull-up control module 01 starts the circuit by receiving a first preceding stage cascade signal Tn−4, and the pull-down clearing module 04 receives the subsequent stage cascade signal to clearing reset the level pull-up control node netAn of the current stage.

In this embodiment, the first node maintaining module in the first sub-maintaining module includes a first pull-up control node maintaining module, a first scan signal maintaining module, and a first cascade signal maintaining module, which are respectively used for maintaining the pull-up control node netAn, the scanning signal Gn of the current stage and the cascade signal Tn of the current stage. The second node maintaining module in the second sub-maintaining module includes a second pull-up control node maintaining module, a second scan signal maintaining module, and a second cascade signal maintaining module, which are respectively used for maintaining the pull-up control node netAn and the current stage scan signal Gn and the cascade signal Tn of the current stage. The first and second pull-up control node maintaining modules are the same as those in the second embodiment, and the first and second scan signal maintaining modules are the same as those in the first embodiment and the second embodiment. They are not described herein again.

The first maintaining control node generating module in the first sub-maintaining module and the second maintaining control node generating module in the second sub-maintaining module are substantially the same as the structures in the first to third embodiments, except that the seventh thin film transistor M7A in the first maintaining control node generating the module. and the seventeenth thin film transistor M7B in the second maintaining control node generating module are connected to each other and to the first preceding stage cascade signal Tn−4.

In this embodiment, the cascade module 02 includes an eleventh thin film transistor M11. The gate of the eleventh thin film transistor M11 is connected to the pull-up control node netAn, the source is connected to the clock signal CKm of the current stage, and the drain is connected to the current stage cascade signal Tn, for outputting the current stage cascade signal Tn to the cascade signal line of the current stage, and pull-down and clear the cascade signal of the current stage.

In this embodiment, the first cascade signal maintaining module and the second cascade signal maintaining module are symmetrically designed. The first cascade signal maintaining module includes a fourteenth thin film transistor M14A, and the second cascade signal maintaining module includes a twenty-fourth film transistor M14B.

The gate of the fourteenth thin film transistor M14A is connected to the first maintaining control node netBn, the source is connected to the current stage cascade signal Tn, and the drain is connected to the low level VSS, for maintaining the current stage cascade signal Tn during the inactive period.

The gate of the twenty-fourth thin film transistor M14B is connected to the second maintaining control node netCn, the source is connected to the current stage cascade signal Tn, and the drain is connected to the low level VSS, for maintaining the current stage cascade signal Tn during the inactive period.

In this embodiment, the pull-up control module 01 includes a first thin film transistor M1. The gate of the first thin film transistor M1 is connected to the first preceding stage signal, the source level is connected to the high level, and the drain is connected to the pull-up control node netAn, for pre-charging the pull-up control node netAn. In this embodiment, the first preceding stage signal is the first preceding stage cascade signal Tn−4, and the first preceding stage cascade signal Tn−4 is the signal from the fourth stage preceding the current stage cascade signal Tn. Actually, as long as the signal is the cascade signals preceding the cascade signal Tn of the current stage, such as Tn−3, Tn−2, etc., it can be implemented, and is within the protection scope of the present invention.

In the embodiment, the pull-down clearing module 04 includes a ninth thin film transistor M9. The gate of the ninth thin film transistor M9 is connected to a subsequent stage signal, the source is connected to the pull-up control node node netAn, and the drain is connected to the low level VSS, so that the subsequent stage signal is received to clearing reset the pull-up control node netAn. In this embodiment, the subsequent stage signal is the subsequent stage cascade signal Tn+6, and the subsequent stage cascade signal Tn+6 is the signal from the sixth stage subsequent to the current stage cascade signal Tn. In fact, as long as the signal is the cascade signal subsequent to the cascade signal Tn of the current stage, such as Tn+1, Tn+2, Tn+5, etc., it can be implemented and is within the protection scope of the present invention.

In this embodiment, the clearing reset module 06 is connected to the pull-up control node netAn, the current stage scan signal Gn, and the current stage cascade signal Tn, respectively. The clearing reset module 06 includes a second thin film transistor M2, a twelfth thin film transistor M12, and a fourth thin film transistor M4. Compared with the foregoing embodiments, in this embodiment the fourth thin film transistor M4 that performs the clearing reset of the current stage cascade signal Tn is added to the clearing reset module 06.

The gate of the second thin film transistor M2 is connected to the clearing reset signal CLR, the source is connected to the pull-up control node netAn, and the drain is connected to the low level VSS, for performing the clearing reset of the pull-up control node netAn.

The gate of the twelfth thin film transistor M12 is connected to the clearing reset signal CLR, the source is connected to the scan signal Gn of the current stage, and the drain is connected to the low level VSS, for performing the clearing reset of the scan signal Gn of the current stage.

The gate of the fourth thin film transistor M4 is connected to the clearing reset signal CLR, the source is connected to the current stage cascade signal Tn, and the drain is connected to the low level VSS, for performing the clearing reset of the cascade signal Tn of the current stage.

In some embodiments, the gate driving unit circuit may further include a nineteenth thin film transistor M1A and a twentieth thin film transistor M4A for maintaining the pull-up control node. The gate of the nineteenth thin film transistor M1A is connected to the preceding stage clock signal CKm−2, the source is connected to a second preceding stage signal, and the drain is connected to the pull-up control node netAn. The second preceding stage signal may be a second preceding stage cascade signal Tn−2. The gate of the twentieth thin film transistor M4A is connected to the startup signal GSP, the source is connected to the pull-up control node netAn, and the drain is connected to the low level VSS.

In this embodiment, the first and second pull-up control node maintaining modules, the first and second scan signal maintaining modules, the first and second cascade signal maintaining modules, and the first and second maintaining control node generating modules are all symmetrically designed respectively, and are controlled by the first low frequency clock signal LC1 and the second low frequency clock signal LC2, which are opposite in phase, thereby achieving alternate operation during the inactive period, maintaining the pull-up control node netAn, the current stage scanning signal Gn, and the current stage cascade signal Tn at a low level without being interfered by other signals, and ensuring the reliability of the circuit. In addition, in this embodiment, by adding a separate cascade module, which is responsible for generating a current stage cascade signal to transmit to and start the circuit of the subsequent stage, the current stage cascade signal Tn and the scanning signal Gn of the current stage are independent, and can effectively maintain the internal nodes of the circuit, and avoid the influence of the the current stage scanning signal Gn on the circuit cascade, solving the defects in the cascade design of the prior art. Because no clock control is required for maintaining, the problem of reducing the circuit design margin due to the increase in signal line load caused by the increase in TFT size is avoided.

It should be noted that the cascade module 02 and the first and second cascade signal maintaining modules corresponding thereto may be used in the foregoing first, second and third embodiments. It is also possible to add the improved parts of the first embodiment, the second embodiment, or the third embodiment to this embodiment, and perform combination thereof to form a new embodiment, which will not be discussed here. In the foregoing embodiments, the description of each embodiment has its own emphasis. Common features and the parts that are not described in detail in one embodiment can be referred to in the relevant descriptions of other embodiments.

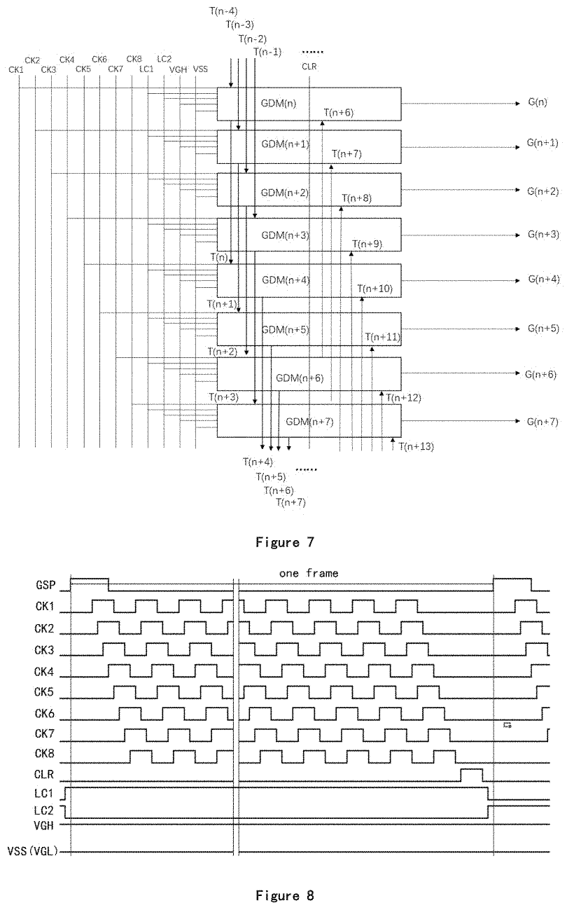

FIG. 7 is a schematic structural diagram of a gate driving circuit according to an embodiment of the invention. The figure shows a gate drive circuit that uses eight clocks to drive, but the number of clock signals in actual applications can be determined according to the load of the panel and the drive capability of the circuit. The gate driving circuit includes a plurality of stages of the gate driving unit circuits of the foregoing embodiment, and further includes a signal input portion (such as CK1-CK8, LC1, LC2, VGH, VSS in the figure) and a scan signal (G(n)−G(n+7)) outputted by the circuit. When the gate driving unit circuit of the fourth embodiment is employed, a cascade portion (such as T(n−4)−T(n+13) in the figure) is further included.

FIG. 8 is a schematic diagram of driving signals of a gate driving circuit according to an embodiment of the invention.

As shown in FIG. 8:

GSP is the startup signal, responsible for starting the circuit of the preceding stage;

CK1-CK18 are driving high-frequency clock signals, which are mainly responsible for generating the scanning signal of the current stage and the cascade signal of the current stage;

LC1 and LC2 are the first low frequency clock signal and the second low frequency clock signal having opposite phases, and the frequencies of LC1 and LC2 are lower than the high frequency clock signal, but the specific frequency needs to be determined according to panel characteristics and TFT element characteristics;

VGH is a constant voltage high level control signal, which is the high level in the foregoing embodiments;

VSS is a constant voltage low level control signal, which is the low level in the foregoing embodiments;

CLR is the clearing reset signal, which is mainly responsible for the charge clearing of the internal nodes of the circuit at the end of each frame and when the device is turned on and off.

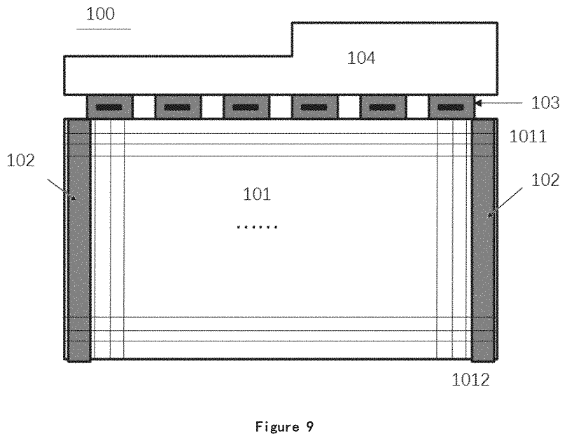

FIG. 9 is a schematic structural view of a liquid crystal display device according to an embodiment of the invention. As shown in FIG. 9, the liquid crystal display device includes a liquid crystal display substrate 101, a gate driver 102 and a source driver 103 respectively connected to the liquid crystal display substrate 101, and a circuit board 104 connected with the gate driver 102 and the source driver 103. The gate driver 102 is disposed inside the liquid crystal display substrate 101. The liquid crystal display substrate 101 is provided with a plurality of scanning lines Gx 1011 and a plurality of data lines Sy 1012 which intersect with each other vertically and horizontally. The scanning line 1011 is provided with a gate. The driver 102 is coupled to the plurality of scan lines 1011 and provides signals to the scan lines 1011. The source drivers 103 are coupled to the plurality of data lines 1012 and provide signals to the data lines 1012.

The gate driver 102 is provided with the gate driving circuit of the above embodiments, and the circuit board 104 is provided with a level shift, a timing controller chip (T-CON), a GIP circuit, etc. The circuit board outputs a high level VGH, a low level VSS, a current stage clock signal CKm, a preceding stage clock signal CKm−2, a subsequent stage clock signal, a first low frequency clock signal LC1, a second low frequency clock signal LC2, a startup signal GSP, and a clearing reset signal CLR to the gate drive circuit.

It should be noted that the above embodiments can be freely combined as needed. The above description are only some preferred embodiments of the present invention. It should be noted that for those skilled in the art, without departing from the principle of the present invention, some changes and improvements can be made, and these changes and improvements should also be considered to fall within the protection scope of the present invention.

1-27. (canceled)

28. A gate driving unit circuit, characterized in comprising: a pull-up control module, a pull-up module, a pull-down clearing module, and a maintaining module; wherein the maintaining module comprises a first sub-maintaining module and a second sub-maintaining module, which are symmetric to each other, the first sub-maintaining module inputs a first low frequency clock signal, and the second sub-maintaining module inputs a second low frequency clock signal that is opposite in phase to the first low frequency clock signal, the first sub-maintaining module and the second sub-maintaining module alternately operate under the control of the first low frequency clock signal and the second low frequency clock signal for maintaining the internal node signal at a low level during the inactive period of a display scan.

29. The gate driving unit circuit according to claim 28, characterized in that, said first sub-maintaining module comprises a first maintaining control node generating module and a first node maintaining module, and said second sub-maintaining module comprises a second maintaining control node generating module and a second node maintaining module; the first maintaining control node generating module is for generating a first maintaining control node, and the second maintaining control node generating module is for generating a second maintaining control node; the first node maintaining module maintains the internal node signal at a low level based on the control of the first maintaining control node, and the second node maintaining module maintains the internal node signal at a low level based on the control of the second maintaining control node;
the first maintaining control node generating module includes a fifth thin film transistor, a sixth thin film transistor, and a seventh thin film transistor; wherein for the fifth thin film transistor, the gate is connected to the first low-frequency clock signal, the source is connected to a high level, and the drain is connected to the first maintaining control node; for the sixth thin film transistor, the gate is connected to a pull-up control node, the source is connected to the first maintaining control node, and the drain is connected to a low level; and for the seventh thin film transistor, the gate is connected to a first preceding stage scanning signal, the source is connected to the first maintaining control node, and the drain is connected to a low level;
the second maintaining control node generating module includes a fifteenth thin film transistor, a sixteenth thin film transistor, and a seventeenth thin film transistor; wherein for the fifteenth thin film transistor, the gate is connected to a second low frequency clock signal, the source is connected a high level, the drain is connected to the second maintaining control node; for the sixteenth thin film transistor, the gate is connected to the pull-up control node, the source is connected to the second maintaining control node, and the drain is connected to the low level; and for the seventeenth thin film transistor, the gate is connected to the first preceding stage scan signal, the source is connected to the second maintaining control node, and the drain is connected to the low level.

30. The gate driving unit circuit according to claim 29, wherein the first maintaining control node generating module comprises a third thin film transistor, and the gate of the third thin film transistor is connected to the second low frequency clock signal, the source is connected to the first maintaining control node, and the drain is connected to the low level for performing a clearing reset of the first maintaining control node;
the second maintaining control node generating module includes a twenty-second thin film transistor, the gate of the twenty-second thin film transistor is connected to the first low frequency clock signal, the source is connected to the second maintaining control node, and the drain is connected to a low level for clearing reset of the second maintaining control node.

31. The gate driving unit circuit of claim 29, wherein the first node maintaining module comprises a first scan signal maintaining module for maintaining a scan signal of the current stage, and the second node maintaining module comprises a second scan signal maintaining module that maintains the scan signal of the current stage;
the first scan signal maintaining module comprises a thirteenth thin film transistor, and for the thirteenth thin film transistor, the gate is connected to the first maintaining control node, the source is connected to the scan signal of the current stage, and the drain is connected to the low level; the second scan signal maintaining module includes the twenty-third thin film transistor, and for the twenty-third thin film transistor, the gate is connected to the second maintaining control node, the source is connected the scan signal of the current stage and the drain is connected to the low level.

32. The gate driving unit circuit according to claim 29, wherein said first node maintaining module comprises a first pull-up control node maintaining module for maintaining the pull-up control node, and said second node maintaining module comprises a second pull-up control node maintaining module for maintaining the pull-up control node;
the first pull-up control node maintaining module comprises an eighth thin film transistor, and for the eighth thin film transistor, the gate is connected to a first maintaining control node, the source is connected to the pull-up control node, and the drain is connected to the low level; the second pull-up control node maintaining module includes an eighteenth thin film transistor, and for the eighth thin film transistor, the gate is connected to the first maintaining control node, the source is connected to the pull-up the control node and the drain is connected to the low level.

33. The gate driving unit circuit of claim 29, further comprising a cascade module, wherein the cascade module is configured to output the cascade signal of the current stage; the cascade module comprises an eleventh thin film transistor, the gate of the eleventh thin film transistor is connected to the pull-up control node, the source is connected to the clock signal of the current stage, and the drain is connected to the cascade signal of the current stage.

34. The gate driving unit circuit according to claim 33, wherein the first node maintaining module comprises a first cascade signal maintaining module for maintaining the cascade signal of the current stage, and the second node maintaining module comprises a second cascade signal maintaining module for maintaining the cascade signal of the current stage; the first stage signal maintaining module comprises a fourteenth thin film transistor, and for the fourteenth thin film transistor, the gate is connected to the first maintaining control node, the source is connected to the cascade signal of the current stage, and the drain is connected to the low level; the second cascade signal maintaining module includes a twenty-fourth thin film transistor, and for the twenty-fourth thin film transistor, the gate is connected to the second maintaining control node, the source is connected to the cascade signal of the current stage, and the drain is connected to the low level.

35. The gate driving unit circuit of claim 28, wherein the pull-up control module is configured to receive a first preceding stage scan signal to activate the current stage circuit, and comprises a first thin film transistor, the gate and the source of the first thin film transistor are connected to the first preceding stage scan signal, and the drain is connected to the pull-up control node, for receiving the first preceding stage scan signal to activate the current stage circuit.

36. The gate driving unit circuit according to claim 33, wherein the pull-up control module is configured to receive a first preceding stage cascade signal to activate the current stage circuit, and comprises a first thin film transistor, the gate of the first thin film transistor is connected to the first preceding stage cascade signal, the source is connected to a high level, and the drain is connected to the pull-up control node.

37. The gate driving unit circuit of claim 28, wherein the pull-down clearing module is configured to receive a subsequent stage scan signal to perform a clearing reset of the pull-up control node, and comprises a ninth thin film transistor, the gate of the ninth thin film transistor is connected to the subsequent stage scan signal, the source is connected to the pull-up control node, and the drain is connected to the low level.

38. The gate driving unit circuit according to claim 33, wherein the pull-down clearing module is configured to receive a subsequent stage cascade signal to perform a clearing reset of the pull-up control node, and comprises a ninth thin film transistor, the gate of the ninth thin film transistor is connected to the subsequent stage cascade signal, the source is connected to the pull-up control node, and the drain is connected to the low level.

39. The gate driving unit circuit according to claim 28, further comprising an auxiliary scan signal maintaining module, wherein the auxiliary scan signal maintaining module comprises a twenty-first thin film transistor, and the gate of the twenty-first thin film transistor is connected to the subsequent stage clock signal, the source is connected to the scanning signal of the current stage, and the drain is connected to the low level.

40. The gate driving unit circuit according to claim 28, further comprising a nineteenth thin film transistor and a twentieth thin film transistor for maintaining the pull-up control node; for the nineteenth thin film transistor, the gate is connected to a preceding stage clock signal, the source is connected to a second preceding stage scan signal, the drain is connected to the pull-up control node; for the twentieth thin film transistor, the gate is connected to a startup signal, the source is connected to the pull-up control node, and the drain is connected to the low level.

41. A gate driving unit circuit according to claim 33, further comprising a nineteenth thin film transistor and a twentieth thin film transistor for maintaining the pull-up control node; for the nineteenth thin film transistor, the gate is connected to a preceding stage clock signal, the source is connected to a second preceding stage cascade signal, the drain is connected to the pull-up control node; for the twentieth thin film transistor, the gate is connected to a startup signal, the source is connected to the pull-up control node, and the drain is connected to the low level.

42. The gate driving unit circuit according to claim 33 wherein the first maintaining control node generating module includes a fifth thin film transistor, a sixth thin film transistor, and a seventh thin film transistor; wherein for the fifth thin film transistor, the gate is connected to the first low-frequency clock signal, the source is connected to a high level, and the drain is connected to the first maintaining control node; for the sixth thin film transistor, the gate is connected to a pull-up control node, the source is connected to the first maintaining control node, and the drain is connected to a low level; and for the seventh thin film transistor, the gate is connected to a first preceding stage cascade signal, the source is connected to the first maintaining control node, and the drain is connected to a low level;
the second maintaining control node generating module includes a fifteenth thin film transistor, a sixteenth thin film transistor, and a seventeenth thin film transistor; wherein for the fifteenth thin film transistor, the gate is connected to a second low frequency clock signal, the source is connected a high level, the drain is connected to the second maintaining control node; for the sixteenth thin film transistor, the gate is connected to the pull-up control node, the source is connected to the second maintaining control node, and the drain is connected to the low level; and for the seventeenth thin film transistor, the gate is connected to the first preceding stage cascade signal, the source is connected to the second maintaining control node, and the drain is connected to the low level.

43. The gate driving unit circuit of claim 35 wherein the source of the first thin film transistor is disconnected from the first preceding stage scan signal and connected to a high level.

44. The gate driving unit circuit of claim 28, further comprising a clearing reset module, configured to perform a clearing reset of the pull-up control node and the current stage scan signal; the clearing reset module includes a second thin film transistor and a twelfth thin film transistor, wherein for the second thin film transistor, the gate is connected to a clearing reset signal, the source is connected to the pull-up control node, and the drain is connected to a low level; and for the twelfth thin film transistor, the gate is connected to the clearing reset signal, the source is connected to the scan signal of the current stage, and the drain is connected to the low level.

45. The gate driving unit circuit according to claim 33, further comprising a clearing reset module, configured to perform a clearing reset of the pull-up control node, the current stage scanning signal, and the current stage cascade signal; the clearing reset module includes a second thin film transistor, a twelfth thin film transistor and a fourth thin film transistor; for the second thin film transistor, the gate is connected to the clearing reset signal, the source is connected to the pull-up control node, and the drain is connected to the low level; for the twelfth thin film transistor, the gate is connected to the clearing reset signal, the source is connected to the scan signal of the current stage, and the drain is connected to the low level; for the fourth thin film transistor, the gate is connected to the clearing reset signal, the source is connected to the current stage cascade signal, and the drain is connected to low level.

46. A gate driving circuit, comprising a plurality stages of the gate driving unit circuit according to claim 28.

47. A liquid crystal display device, comprising the gate driving circuit according to claim 46.
